(19) United States
(12) Patent Application Publication
(10) Pub. No.: US 2003/0172069 A1
(43) Pub. Date: Sep. 11, 2003

(54) Access management server, disk array system, and access management method thereof

(76) Inventors: Yasufumi Uchiyama, Ebina (JP); Tomohiro Sonomura, Yokosuka (JP); Toshihiko Kawano, Ayase (JP); Daisuke Shinohara, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/229,130

(22) Filed: Aug. 28, 2002

(30) Foreign Application Priority Data
Mar. 8, 2002 (JP) 2002-063646

(51) Int. Cl. G06F 17/30

(52) U.S. Cl. 707/9

(57) ABSTRACT

Access from a user to a plurality of disk units is managed by establishing a change authority over configuration information of logical volumes for each user ID at a management client and by storing the change authority as user information and access right information in an access management server. The access management server generates volume configuration information of a disk array unit based on the stored user information and access right information and then establishes the volume configuration information at the disk array unit.

### BACKGROUND OF THE INVENTION

The present invention relates to an access management server, a disk array system, and an access management method thereof.

In recent years, the amount of information to be handled by a computer system used in a corporation or the like has been dramatically increased together with the capacity of a disk unit for storing data being increasingly expanded. For example, it is not uncommon for some magnetic disk units to have a capacity of several terabytes (TB). With regard to such a disk unit, for example, the JP-A-9-274544 discloses relocation of logical disk units managed by a storage control unit. Specifically, it discloses that, from the judgment made by a maintenance engineer based on access information, a logical disk unit with a higher access frequency is relocated to a faster physical disk unit and a logical disk unit with a higher ratio of sequential access is relocated to a physical disk unit with a higher sequential access performance.

### SUMMARY OF THE INVENTION

The above-mentioned prior art does not describe any assignment of storage devices on a user-by-user or host-by-host basis.

Namely, if the capacity of those storage devices is increased, they would be shared by a plurality of users in order to effectively use them. Also, a Storage Service Provider (SSP) or the like could offer a service to divide a storage device into several partitions and to provide these divided partitions for the users. In this case, a manager would be required to assign the regions of storage device on a user-by-user or host-by-host basis. In addition, it would be necessary for a user to which a region of storage is assigned to make the region available to other users for effective use of it.

The present invention has been made in light of the problems described above and it is an object of the present invention to provide a method or apparatus wherein storage regions are assigned to users or hosts and access authorities over the assigned storage regions can be established on a user-by-user or host-by-host basis.

To attain the above-described object, the main aspect of the present invention is that access from a user to a plurality of disk units is managed and that when a request to access logical volumes stored in each of the disk units is received from the user, it is determined whether the access is permitted or prohibited based on access right information defined for each user with respect to each logical volume stored in the each disk unit.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for showing an overall configuration including a storage system;

FIG. 2 shows a table for an example of logical volume configuration information provided for a disk array unit;

FIG. 3 shows a table for an example of user information provided for a disk array unit;

FIG. 4 shows an access management table for an example of access right information provided for a disk array unit;

FIG. 5 shows a table for an example of switch information used for an access management method;

FIG. 6 shows the operation of the overall system;

FIG. 7 is a flow chart for showing a first embodiment of the access management method;

FIG. 8 shows an example of a screen to define configuration changes to logical volumes;

FIG. 9 shows an example of the screen to establish access rights to logical volumes;

FIG. 10 shows volume configuration information used for the access management method;

FIG. 11 shows access restriction information including logical volumes and authorities defined therefor;

FIG. 12 is a flow chart for showing a second embodiment of the access management method; and

FIG. 13 is a flow chart for showing a third embodiment of the access management method.

### DESCRIPTION OF THE EMBODIMENTS

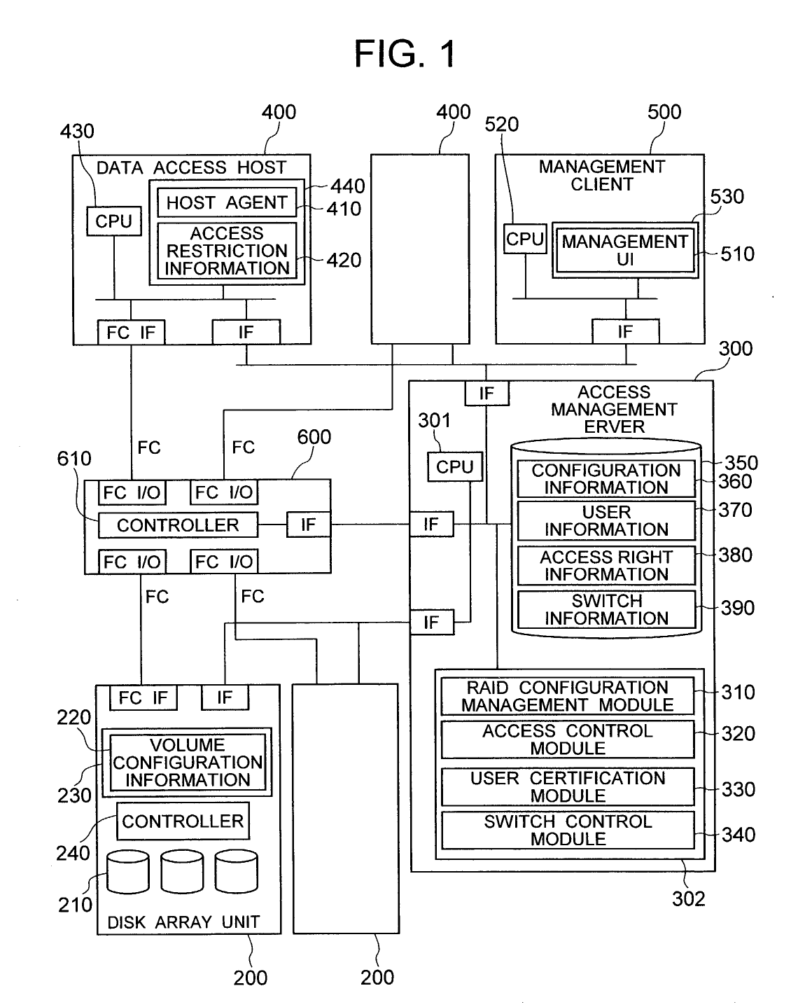

Referring to the drawings, an access management server, a disk array system, and an access management method thereof according to embodiments of the present invention will be described below. FIG. 1 shows a block diagram of the overall system, which comprises a plurality of data access hosts 400, a management client 500, an access management server 300, a plurality of disk array units 200, and a switch 600. The data access hosts 400, the management client 500, the access management server 300, the disk array units 200, and the switch 600 are connected through a network according to, for example, the Internet protocol. In addition, the data access hosts 400, the switch 600, and the disk array units 200 are connected to another network according to a fiber channel protocol. In FIG. 1, interfaces to the network according to the IP protocol are designated as “IF” and interfaces to the network according to the fiber channel protocol are designated as “FCIF.” Moreover, a system comprised of the disk array units 200 and the access management server 300 is referred to as a disk array system.

The disk array units 200 are constituted by Redundant Array for Inexpensive Disk (RAID) units. The access management server 300 manages user access to the disk array units 200.

Each of the data access hosts 400 is a server machine which uses logical volumes of the disk array units 200 and has a memory 440 and a CPU 430 which executes programs stored in the memory. The memory 440 stores programs of a host agent 410 and access restriction information 420.

The management client computer 500 includes a memory 530 and a CPU 520 which executes programs stored in the memory 530. The memory 530 also stores programs of a management user interface (UI; usually a console) 510. The management UI 510 notifies the access management server 300 of information such as ID entered by a user (storage manager). The management client computer 500 defines the configuration of logical volumes and establishes user access rights based on an operational input by the user (storage manager) through the management UI 510.

The RAID units constituting the disk array units 200 are disk storage units, each having a function to provide the data access hosts 400 with one or more volumes as a logical storage area. Each of the disk array units 200 has a plurality of disk units 210, a controller 240, and a memory 230. The memory 230 stores volume configuration information 220 in which a logical volume configuration is defined.

The access management server 300, for example, establishes the volume configuration information 220 in the disk array unit 200 and controls the switch 600 for controlling data access paths. Specifically, the access management server 300 includes a memory 302, a CPU 301 which executes programs stored in the memory 302, and a database (DB) unit 350. The memory 302 also stores programs such as a user certification module 330, an access control module 320, a RAID configuration management module 310, and a switch control module 340.

The user certification module 330 certifies a user who logged in the system through the data access host 400 or the management client computer 500. Information required for the certification with respect to the user (hereinafter simply referred to as “user information 370”) is acquired from the DB unit 350.

The access control module 320 determines whether access from the user is permitted or prohibited, based on information for access rights stored in the DB unit 350 (hereinafter simply referred to as “access right information 380”).

The RAID configuration management module 310 acquires the volume configuration information 220 from the disk array unit 200 and establishes defined volume configuration information as volume configuration information of the disk array unit 200.

The switch control module 340 allows for data access to logical volumes, if it is permitted by the access control module 320. Specifically, with the permission of the access control module 320, the switch control module 340 transmits switch information 390 to the switch 600 for establishing a path.

The DB unit 350 stores information on the configuration of logical volumes defined by the volume configuration information 220 in the disk array unit 200 (hereinafter simply referred to as “configuration information 360”). In addition, the DB unit 350 stores the user information 370 required for user certification, the access right information 380 defined for each user with respect to each logical volume, and the switch information 390 for establishing a switch path, as described above.

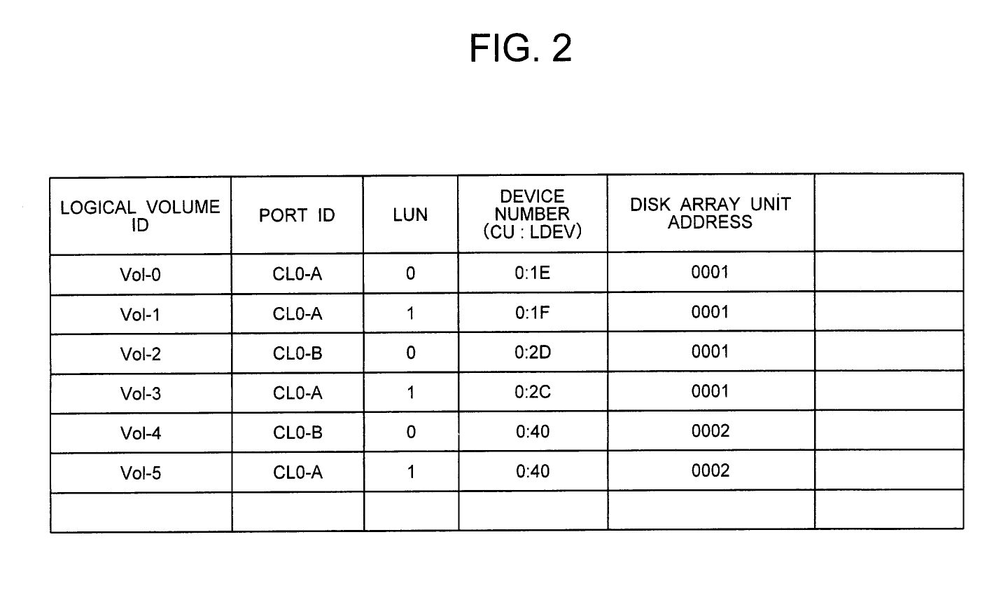

Referring to a table for showing configuration information in FIG. 2, a specific example of the configuration information mentioned above will be described below. As shown in FIG. 2, configuration information items include IDs of logical volumes (logical volume ID), and a port ID (port address), a logical unit number (LUN), a device number (logical device address (LDEV)), and a disk array unit address assigned to each logical volume ID, respectively. A logical volume ID is an ID which indicates a logical volume (logical storage volume) accessible to the data access host (server) 400. A port ID, a LUN, and a device number are used to access the data access host 400. These information items are managed with respect to all the disk array units that are subject to the management of the system.

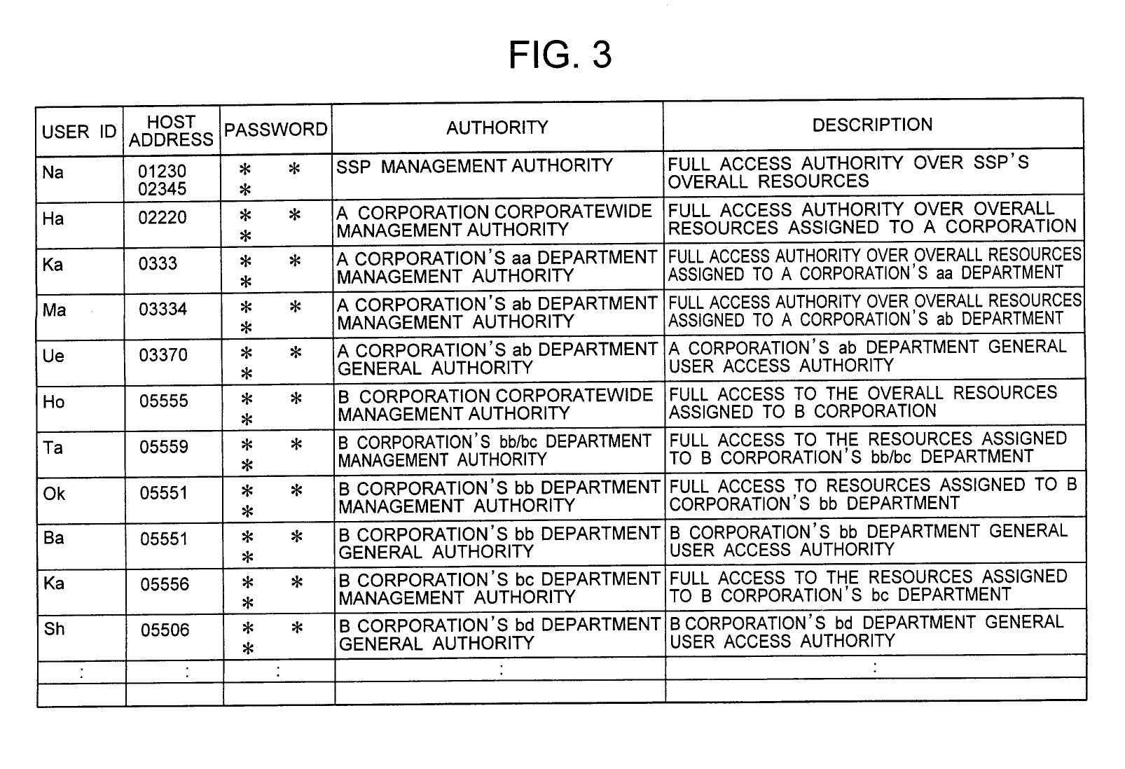

Referring to a table for showing user information in FIG. 3, a specific example of the user information 370 mentioned above will be described below. As shown in FIG. 3, user information items include IDs of users (user ID), and a host address, a password, and an access right which indicates the role of a user, all assigned to each user ID, respectively. A host address is a physical address (world wide name) assigned to the data access host 400 which a user uses. A plurality of physical addresses may be defined for a user ID. For example, with respect to the user ID “Na” in the first row of the table in FIG. 3, two addresses “01230” and “02345,” a password, and an access right called “Storage Service Provider (SSP) management authority” are defined. The SSP management authority means that, as described in the column “Description” of FIG. 3, the full access authority over the overall resources of the SSP (all logical volumes provided for the disk array unit 200 managed by the access management server 300) without limitation is granted to the user. These information items for other user IDs are as described in the table of FIG. 3.

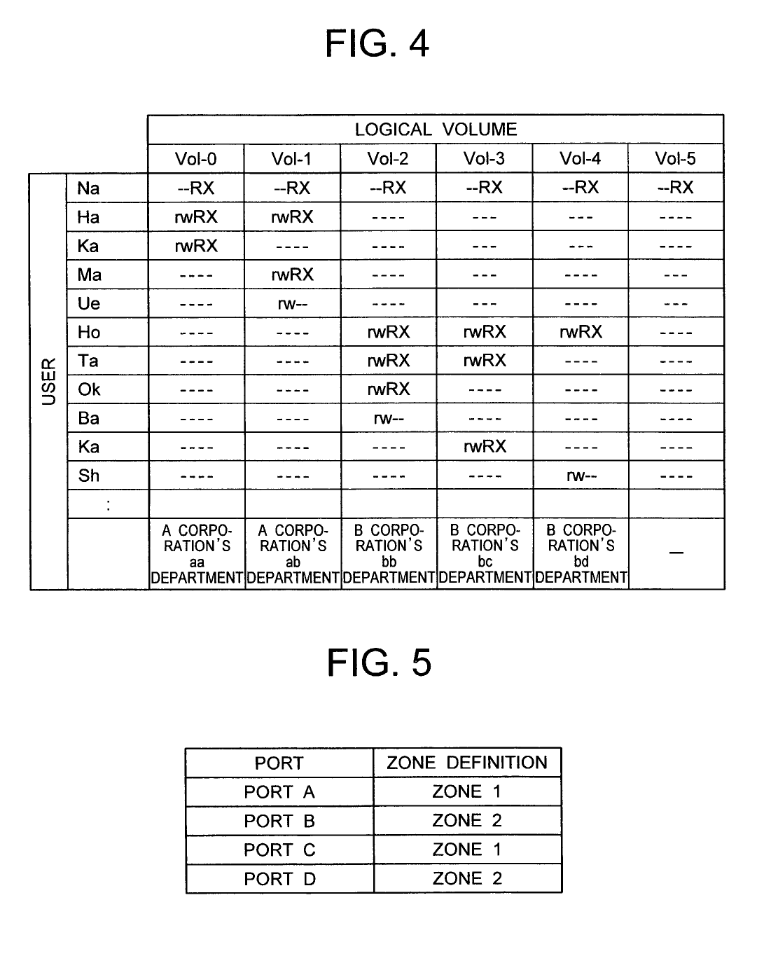

Referring to an access management table for showing access right information in FIG. 4, a specific example of the access right information 380 mentioned above will be described below. As shown in FIG. 4, access right information items include access right information assigned to each user with respect to each logical volume, respectively (including logical volume definition establishment authority information).

For example, the user ID “Na” in the first row of the table in FIG. 4 is an SSP manager. Therefore, the user ID “Na” has the authorities to make a reference (“R” in the Figure) and to make a change (“X” in the Figure) to the definition of the configuration of all storage resources (Vol-0 to Vol-5). Namely, the user ID “Na” is permitted to establish the definition of the logical volumes Vol-0 to Vol-5. On the other hand, the user ID “Na” does not have the authorities to make a reference to (to read out or transfer; “r” in the Figure) and to write (“w” in the Figure) the data itself of the logical volumes (collectively indicated by “--RX” in the Figure). Namely, the user ID “Na” is prohibited to access the data of Vol-0 to Vol-5 (data access).

In addition, the user ID “Ha” in the second row of the table in FIG. 4 is a manager with respect to the overall storage resources (Vol-0, Vol-1) assigned to A Corporation as “A's aa” and “A's ab.” Therefore, the user ID “Ha” has the authorities or priviledges to make a reference (“R” in the Figure) and to make a change (“X” in the Figure) to the definition of the configuration of these logical volumes Vol-0 and Vol-1 as well as the authorities to make a reference to (“r”in the Figure) and to write (“w” in the Figure) the data itself of these logical volumes (collectively indicated by “rwRX” in the Figure). Namely, the user ID “Ha” is permitted to access the data of Vol-0 and Vol-1 (data access). In addition, the user ID “Ha” has no access, such as reference, change, and write, to the logical volumes (Vol-2 to Vol-5) assigned to the corporations other than A Corporation itself (collectively indicated by “---” in the Figure). Namely, the user ID “Ha” is prohibited to establish the definition of the logical volumes Vol-2 to Vol-5.

Furthermore, the user ID “Ka” in the third row of the table in FIG. 4 is a manager only with respect to the logical volume Vol-0 assigned to aa Department of A Corporation and has the authorities to make a reference (“R” in the Figure) and to make a change (“X” in the Figure) to the definition of the configuration thereof as well as the authorities to make a reference to (“r” in the Figure) and to write (“w” in the Figure) the data itself of this logical volume (collectively indicated by “rwRX” in the Figure). In addition, the user ID “Ka” has no access, such as reference, change, and write, to the logical volumes (Vol-1 to Vol-5) assigned to the departments other than aa Department itself (collectively indicated by “---” in the Figure).

Still furthermore, the user ID “Ue” in the fifth row of the table in FIG. 4 is not a manager but a general user in ab Department of A Corporation. Therefore, the user ID “Ue” has the authorities to make a reference to (“r” in the Figure) and to write (“w” in the Figure) the data itself of only the logical volume Vol-1 assigned to ab Department without the authorities to make a reference and to make a change to the definition of the configuration thereof (collectively indicated by “rw--” in the Figure).

Referring to a switch information table for showing switch information in FIG. 5, a specific example of the switch information 390 mentioned above will be described below. As shown in FIG. 5, switch information items include port numbers and zone definition information assigned to the switch.

The switch 600 establishes a path which allows the data access host 400 to perform data access to logical volumes. Specifically, the switch 600 has a controller 610 and establishes a path based on the switch information 390 transmitted by the access management server 300. Namely, port numbers with the same zone defined according to the switch information shown in FIG. 5 are connected to each other. For example, Port A and Port C are connected to each other and Port B and Port D are connected to each other. This allows for establishment of a path between the data access host 400 and logical volumes.

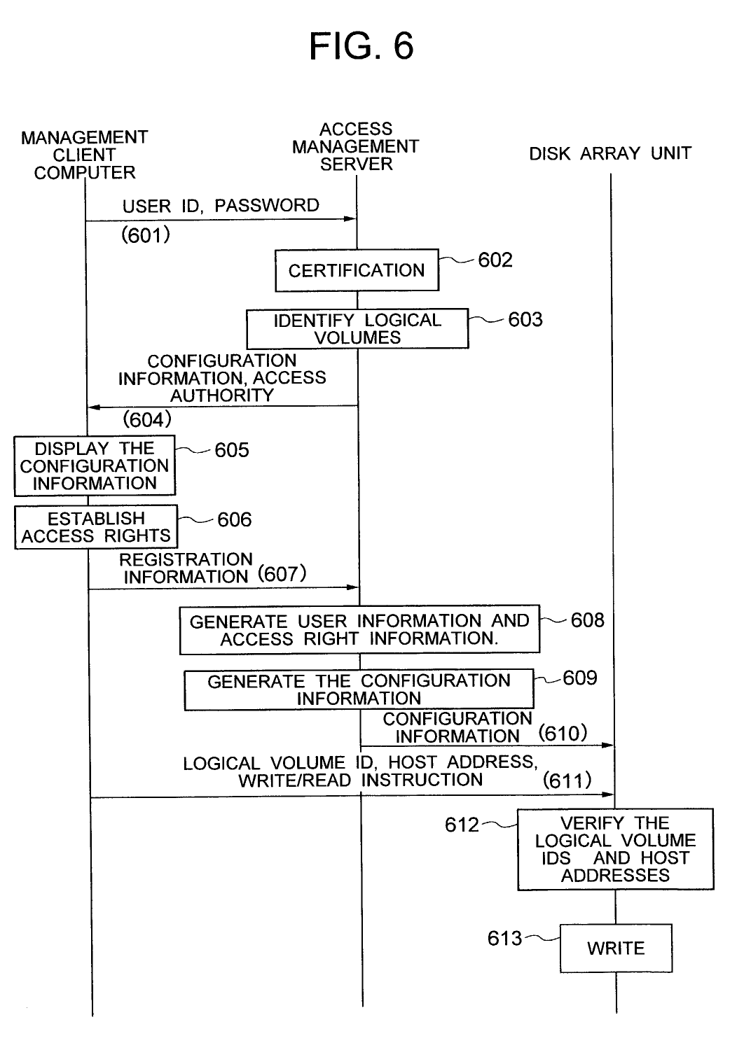

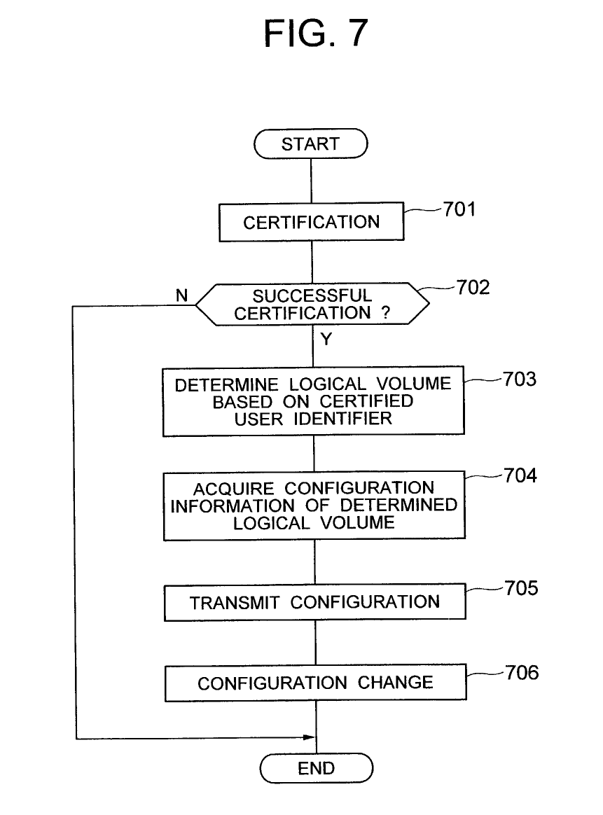

Referring to the overall process in FIG. 6, a flow chart in FIG. 7, and the block diagram in FIG. 1, the operation wherein the user uses the management client computer 500 to make a reference or change to the volume configuration information 220 of the disk array unit 200 through the access management server 300, that is, the establishment operation will be described below.

FIG. 6 shows the operation for establishing the user information 370, the access authorities 380, and the volume configuration information 220.

A user can use the management client computer 500 to establish access authorities for other users. Specifically, the user who has the ID “Na” together with the “full access authority over the overall resources of SSP” as shown in FIG. 3 can establish a “full access authority over the overall resources assigned to A Corporation” as an access authority for the user with the ID “Ha.” The user with the ID “Ha” can in turn access authorities for the users with the IDs “Ka” and “Ma,” respectively, with respect to the overall resources assigned to A Corporation. Thus, access rights can be established in a hierarchical manner.

First, with respect to the user information as shown in FIG. 3, establishment of the access authority for the user ID “Na” and consequently establishment of the access authority for the user ID “Ha” will be described below. In the following description, the expression “user ID “**”” means the user ID used by the “user **.”

When the user Na enters the user ID “Na” and a password into the management client computer 500, the user ID and the password are transmitted to the access management server 300 by means of the management UI 510 of the management client 500 (601). The access management server 300 performs certification by means of the user certification module 330 (602), determines that the certification is successful when the user ID and the password match those previously registered with the user information, and then identifies logical volumes to which the user ID “Na” can make a reference or change from the access management table, by means of access control module 320 (603). The volumes Vol-1 to Vol-5 are identified because the access management table in FIG. 4 shows that the user Na can make a reference or change to the configuration of these volumes Vol-1 to Vol-5. The configuration information and the access authority information with respect to the identified logical volumes are transmitted to the management client computer 500 by means of the access control module 320 (604). The transmitted configuration information is displayed on the screen of the management client computer 500 by means of the management UI 510 (605). The user Na uses the screen to establish the access authorities for the user Ha (606).

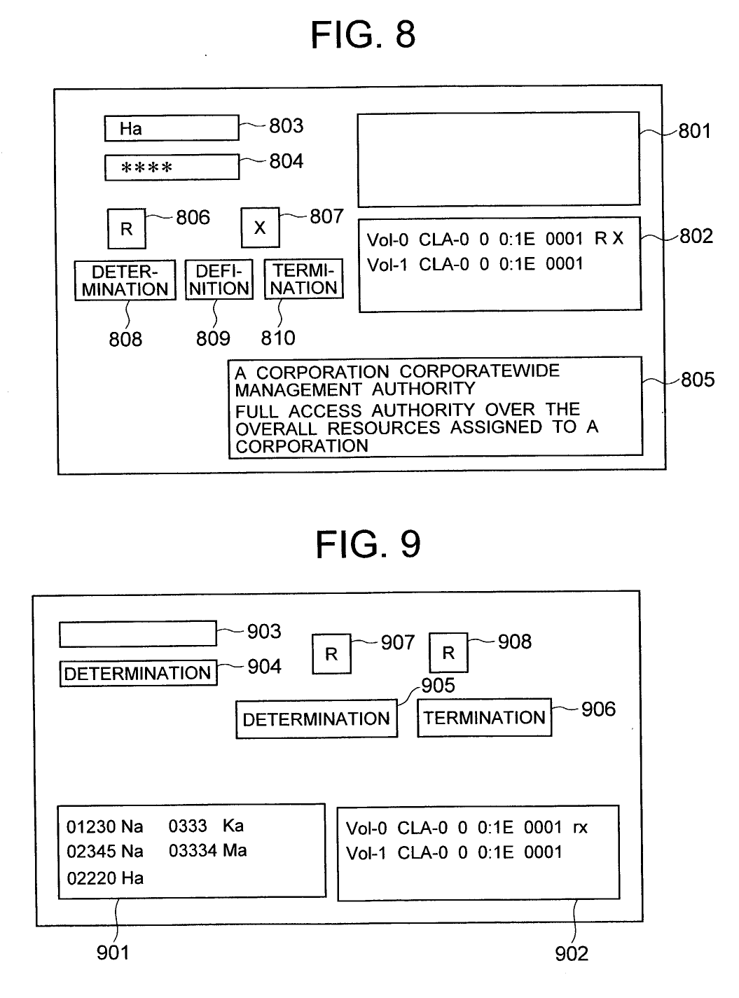

FIG. 8 shows an example of the screen display on the management client computer 500. The management client computer 500 displays an area 801 for displaying the configuration information of logical volumes for which only a reference authority is granted, an area 802 for displaying the configuration information of logical volumes for which reference and configuration change authorities are granted, an area 803 for establishing a user ID, an area 804 for establishing a password, and an area 805 for entering a comment. The screen also displays function buttons for establishing access authorities. Specifically, there are provided a function button 806 for establishing a reference authority (R) for the configuration information and a function button 807 for establishing a change authority (X) for the configuration information. In addition, the screen displays a determination functional button 808 for determining the established access authorities, a definition functional button 809 for transition to another screen to define the data access host and logical volumes, and a termination functional button 810 for terminating the process.

As shown in FIG. 8, the user Na establishes the user ID and password for the user Ha. Then, the user Na selects logical volumes to be assigned to the user Ha. In this case, a mouse or other means is used to specify logical volumes Vol-0 and Vol-1. The specified logical volumes Vol-0 and Vol-1 are displayed in reverse video to indicate that they have been specified by the user Na. Logical volumes which may be specified are limited to those displayed in the area 802 and thus logical volumes displayed in the area 801 are not displayed in reverse video even if specified. Then, access authorities with respect to these specified logical volumes are established by specifying them with a mouse or other means. The specified access authorities are displayed for the respective logical volumes. In addition, the user Na enters the description “A Corporation corporatewide management authority: full access authority over the overall resources assigned to A Corporation” in the area 805 as a comment for the access authorities of the user Ha. When all entries are confirmed, the determination button 808 is specified. This determines the established access authorities over the configuration definition information for the user Ha.

If the definition button 809 is specified, another screen to associate the data access host with the logical volumes is displayed as shown in FIG. 9. This screen displays a host display area 901, a volume configuration information display area 902, an area 903 for entering file names of files for which the data access host is registered and a determination button 904, a button 905 for determining the definition for the data access host and volumes, and a button 906 for terminating the process. In addition, in order to establish access authorities, a button 907 for establishing a data reference authority (r) and a button 908 for establishing a data write authority (x) are also displayed. In the volume configuration information display area 902, the volume configuration information transmitted by the access management server is displayed. Namely, the configuration information which may be established by the user Na is displayed. An address and a user ID displayed in the host display area 901 are those displayed when the user Na enters a file name into the area 903. The user Na may enter the address and user ID into the area 901 with a keyboard or other means. When the user Na specifies an address with a mouse or other means, the specified address blinks. When the user Na specifies the buttons 907 and 908 with the address blinking, a data reference authority (r) and a data write authority (x) can be established. When another address is specified, the blinking address will turn into reverse video with the newly-specified address blinking. In this way, authorities are established for the respective addresses. Next, when the user Na specifies logical volume information, the specified logical volume information is displayed in reverse video. When an address and a logical volume to be associated with each other are displayed in reverse video and then the determination button 905 is specified, the association between the address and logical volume displayed in reverse video is established. When a new address or logical volume is specified after the determination button 905 has been specified, the address and logical volume previously displayed in reverse video will turn into original display state with the newly-specified address blinking or with the newly-specified logical volume displayed in reverse video.

When the user Na specifies the termination button 906, the display returns to the screen of FIG. 8, and when the user Na further specifies the termination button 810, the information established by means of the management UI 510 is transmitted to the access management server 300 as registration information (607).

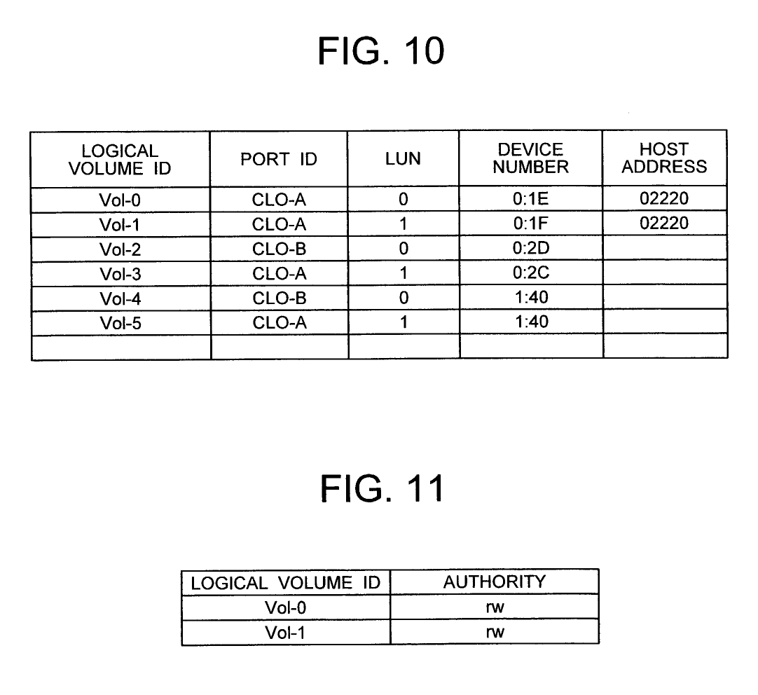

The access management server 300 registers the transmitted registration information with the user information table and the access right information table by means of the access control module 320 (608). Namely, the user ID, the password, and the comment are registered with the user information 307 and the user ID and the access authority are registered with the access management table. This allows the user Ha to be granted the configuration definition reference and change authorities and the data reference and write authorities with respect to the logical volumes Vol-0 and Vol-1, allowing the user Ha to establish access authorities for other users with respect to the logical volumes Vol-0 and Vol-1. Then, configuration information is generated based on the user information 370 and the access right information 380 registered by means of the RAID configuration management module 310 (609). FIG. 10 shows an example of the generated configuration information. In addition, the RAID configuration management module 310 transmits the generated configuration information to the disk array unit 200 (610).

Thus established information can allow for access from the data access host 400 which the user Ha uses to the disk array unit. For example, if the user Ha writes data from the data access host into the disk array unit 200, the logical volume IDs, the host address, a write instruction, and the data to be written are transmitted by the data access host 400 to the disk array unit 200 (611). The disk array unit 200 compares the logical volume IDs and the host address which are transmitted with the logical volume IDs and the host address registered with the volume configuration information (612), and then, if they match, the data is written into the disk unit defined with the logical IDs (613).

As described above, the user Na can establish an access right for the user Ha with respect to logical volumes.

FIG. 7 shows the process of the access management server 300.

As shown in the flow chart of FIG. 7, after the process starts, the user causes the management UI 510 of the management client computer 500 to execute to log in to the access management server 300 and to transmit user information such as IDs. The user certification module 310 of the access management server 300 makes a reference to the user information (FIG. 3) of the DB unit 350 based on the received user information and then performs certification of the logged-in user (701). If the certification is successful (702: YES), the access control module 320 makes a reference to the access right information of the DB unit 350 (the access management table in FIG. 4) to determine (permit) logical volumes which the authenticated user may access (703). Next, the RAID configuration management module 330 acquires from the DB unit 350 the configuration information (FIG. 2) for the logical volumes determined in S703 and transmits it to the management client computer 500. The management UI 510 of the management client computer 500 displays the transmitted configuration information for the logical volumes on the screen. The user performs an operation for changing the configuration (establishing the definition) with respect to the logical volumes in the displayed configuration information, through the management UI 510. When the “termination” displayed on the screen is specified by the user, the management UI 510 transmits the configuration information for the changed logical volumes to the access management server 300.

Then, the configuration information of the DB unit 350 is changed according to the transmitted configuration information for the logical volumes and the changed configuration information is transmitted to the disk array unit 200 by means of the RAID configuration management module 310 (706). The disk array unit 200 stores the transmitted configuration information in the memory 230 as the volume configuration information 220. The controller 240 in the disk array unit 200 controls access to the disk units 210 according to the changed volume configuration information 220.

In this way, with the first embodiment, establishment of the reference and change authorities over the volume configuration information and establishment of the access authority over the logical volumes have been described above. In FIG. 6, the case where the reference and change authorities over the volume configuration information as well as the access authority over the logical volume are to be established, has been shown and described, however, only either of these authorities may be established. This can allow for hierarchical management of the reference and change authorities over the configuration information.

With the first embodiment, the use of the management client 500 and the access management server 300 for establishing the volume configuration information 220 in the disk array unit 200 has been described.

In addition to this feature, the second embodiment manages the access authority over volumes at the data access host.

Specifically, based on the user information 370 and the access right information 380 generated at step 608 of FIG. 6, the access right for each of the data access hosts 400 is identified with respect to each logical volume. For example, for the host address “02220” in the user information shown in FIG. 3, the access authorities are generated with respect to the logical volumes as shown in FIG. 11. Thus generated access restriction information is transmitted to the data access host 400 indicated by the host address after step 610 of FIG. 6 by means of the access control module 320. The data access host 400 stores the transmitted access restriction information in the memory 440 and verifies the access authority over the disk array unit according to the access restriction information for each access to the disk array unit. Specifically, the data access host 400 incorporates a driver for controlling access to the disk array unit. This driver receives from an application logical volume IDs, write/read instructions, and data to be written for a write instruction, and transmits them through the FCIF to the disk array unit. When the access restriction information 430 is established, the driver verifies whether the logical volume IDs and the write/read instructions received from the application have been registered with the access restriction information. If they have been registered, the access is permitted; and if not, the access is rejected.

Such establishment of the access restriction information at the data access host may prevent unauthorized access to the disk array unit, resulting in a reduced load to the network.

It should be noted that the embodiment assumes that each user uses a separate host address and that similar access control may be accomplished by using user IDs and passwords if a plurality of users share a single data access host. Namely, the access restriction information may be managed by means of user IDs and passwords and when a user ID and a password match previously registered ones, the access restriction information established for that user ID may be used.

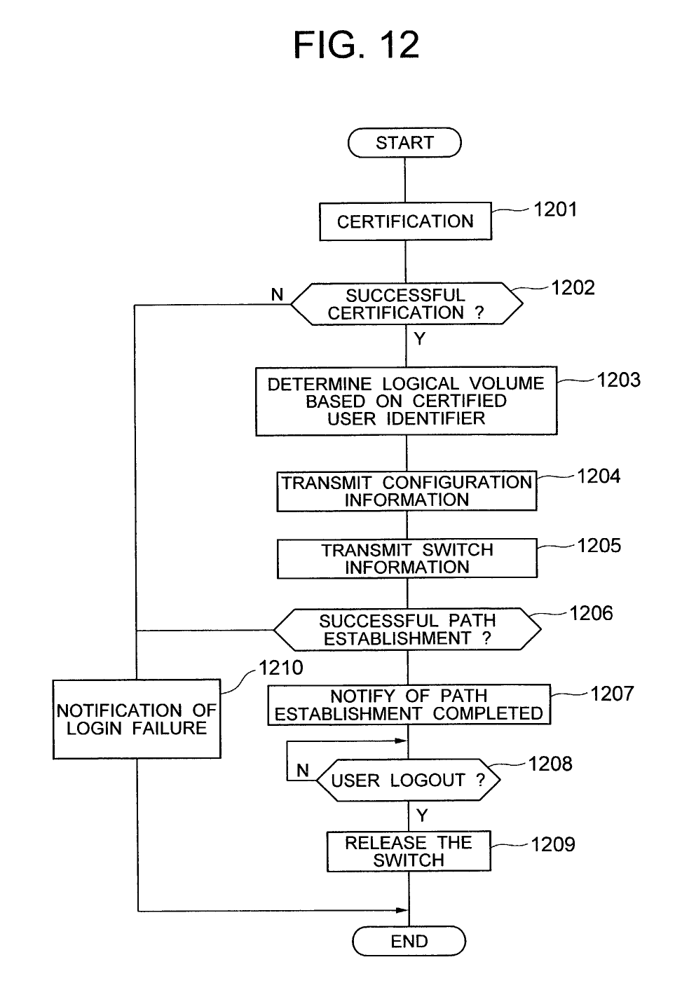

The operation wherein the user uses the data access host 400 to access the data in logical volumes of the disk unit 210 through the access management server 300 for subsequent reference or write operations will be described below with reference to the flow chart in FIG. 12 and the block diagram in FIG. 1.

The user transmits the user ID, a password, and a host address to the access management server 300 by means of the host agent 410 in the data access host 400.

As shown in the flow chart of FIG. 12, after the process starts, the user certification module 330 in the access management server 300 makes a reference to the user information (FIG. 3) in the DB unit 350 to perform an certification operation based on the received user ID, password, and host address (1201). If the certification fails (1201: NO), the user certification module 330 notifies the data access host 400 of login failure (S1210). On the contrary, if the certification is successful (1202: YES), the access control module 320 makes a reference to the access right information (the access management table of FIG. 4) in the DB unit 350 to retrieve information on logical volumes accessible to the authenticated user (1203). For the user ID “Ha” shown in FIG. 4, the retrieved information shows the logical volumes Vol-0 and Vol-1. Namely, FIG. 4 shows that the authority “r” or “w” is defined for the user ID “Ha” with respect to the logical volumes Vol-0 and Vol-1. Then, the retrieved logical volume information is transmitted to the disk array unit 200 together with the user's host address (1204).

The disk array unit 200 registers the host address with the volume configuration information 220 according to the transmitted logical volume information. For example, when the logical volume information “Vol-0” and “Vol-1” as well as the host address “02220” are transmitted, the volume configuration information 220 is as shown in FIG. 10. The host address is defined for the logical volumes “Vol-0” and “Vol-1” in this way. If the host address transmitted through a fiber channel is registered with the logical volume in the volume configuration information 220, the controller 240 in the disk array unit 200 determines that the access is valid and permits the access. If the host address is not registered, notification of access failure is transmitted.

Referring to FIG. 12 again, the process description will be continued. After the logical volume information has been transmitted to the disk array unit at step 400, the access control module 320 issues an instruction to the switch control module 340. The switch control module 340 transmits the switch information 390 to the switch 600 (1205). When the establishment ends with the switch information 390, the controller 610 in the switch 600 transmits a notification of successful path establishment to the access management server 300. When the access control module 320 receives the notification of successful path establishment, it transmits a notification of path establishment completed to the data access host 400 (1207). Upon receipt of the notification of path establishment completed, the data access host 400 starts data access to the disk array unit 200.

When the access control module 320 receives a logout notification of logout from the data access host 400 (1208: YES), it instructs the switch control module 340 to release the switch. The switch control module 340 transmits a release notification to the switch 600 (1209). Upon receipt of the release notification, the controller 610 in the switch 600 releases the switch settings.

In this way, the embodiment has disclosed a user access management method by means of the volume configuration information in the disk array unit and the switch settings.

It should be noted that the present invention may be applicable to a system which is similar to that of FIG. 1 but with no switch or with a switch path being already established. In that case, steps 1205 to 1207 in the process of FIG. 12 may be omitted.

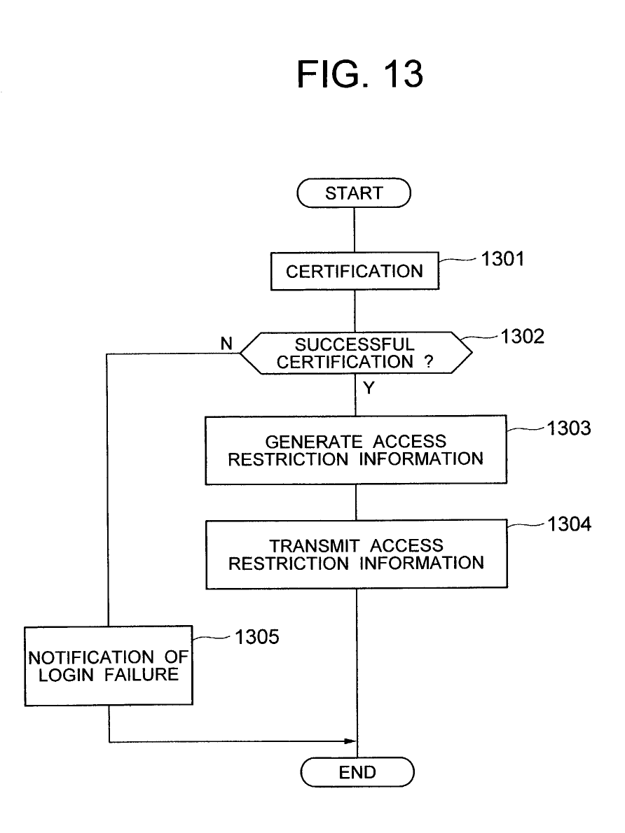

Another operation wherein the user uses the data access host 400 to access the data in logical volumes of the disk unit 210 through the access management server 300 for subsequent reference or write operations will be described below with reference to the flow chart in FIG. 13 and the block diagram in FIG. 1. The user transmits the user ID, a password, and a host address to the access management server 300 by means of the host agent 410 in the data access host 400.

As shown in the flow chart of FIG. 13, after the process starts, the user certification module 330 in the access management server 300 makes a reference to the user information (FIG. 3) in the DB unit 350 to perform an certification operation based on the received user ID, password, and host address (1301). If the certification fails (1302: NO), the user certification module 330 notifies the data access host 400 of login failure (1305). On the contrary, if the certification is successful (1302: YES), the access control module 320 makes a reference to the access right information (the access management table in FIG. 4) in the DB unit 350 to generate access restriction information in which accessible logical volumes and authorities therefor are defined (1303). For the user ID “Ha” shown in FIG. 4, the access restriction information is generated as described above and shown in FIG. 11. The access control module 320 transmits the access restriction information in which logical volumes and authorities therefor are defined as shown in FIG. 11, to the data access host 400 (1304).

The data access host 400 stores the transmitted access restriction information 420 in the memory. The data access host 400 has an application for accessing the disk array unit 200, some drivers, and other programs stored in the memory. When access to the disk array unit 200 is requested by the user, an I/O driver program stored in the memory is executed to make a reference to the access information 420 to determine whether an access authority is granted with respect to the volume to be accessed by request or whether authorities required to meet the request (reference, write) are granted. If the authorities required to meet the request are granted, the host address is transmitted to the disk array unit 200 for executing an access operation. On the contrary, if the authorities required to meet the request are not granted, it is displayed on the screen that no required authority is granted.

As described above, this embodiment can allow the data access host 400 used by the user to control the user's access authority with respect to volumes by generating and notifying the access authority at the access management server 300.

If the control of the switch 600 is also to be included, steps 1206 to 1209 shown in FIG. 12 may be performed after step 1304 of FIG. 13.

While the present invention has been specifically described above based on the embodiments, the present invention is not limited to those embodiments and various changes and modifications can be made without departing the spirit and scope thereof.

Moreover, according to the embodiment, access control can be performed for each user with respect to each logical volume. For example, access control can be accomplished according to the user's task (role).

Namely, access control can be performed on a logical-volume by logical-volume basis.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An access management server for managing access to a plurality of disk units, comprising:
a storage device which stores information regarding logical volumes logically divided and stored in each of said disk units and information for allowing for establishment of an access right over a logical volume for each user identifier; and
a controller which transmits information regarding a logical volume for which establishment of an access right is permitted based on a transmitted user identifier from said storage device.

2. The access management server according to claim 1,
wherein configuration definition information in which logical volumes and host addresses are associated with each other is generated from transmitted access right information with respect to a logical volume, and the generated configuration definition information is transmitted to a disk unit in which a physical disk corresponding to the logical volume is located.

3. An access management server for managing access from a user to a plurality of disk units, comprising:
means for holding access right information defined for each user identifier with respect to logical volumes logically divided and stored in each of said disk units; and
access control means coupled to said holding means for determining whether said access is permitted or prohibited based on the user identifier and said access right information, in response to reception of a request to access said logical volumes.

4. The access management server according to claim 3:
wherein said access is to establish definition of said logical volumes;
said access right information includes logical volume definition establishment authority information indicating whether it is permitted or prohibited to establish the definition of said logical volumes for said access; and
said access control means permits or prohibits establishment of the definition of said logical volumes, based on said logical volume definition establishment authority information.

5. The access management server according to claim 4, comprising:
logical volume definition establishment implementation means for implementing said logical volume definition establishment according to a result of the determination made by said access control means on whether it is permitted or prohibited to establish the definition of said logical volumes.

6. The access management server according to claim 3:
wherein said access is access to data in said logical volumes; and
said access management server comprises path control means for permitting said access to meet said access request based on a result of the determination made by said access control means.

7. A disk array system comprising a disk array unit having a plurality of disk units and an access management server for managing access from a user to said disk array unit,
wherein said access management server comprising the steps of:
means for holding access right information defined for each user identifier with respect to each logical volume stored in each of said disk units; and
access control means for determining whether said access is permitted or prohibited based on said user identifier and said access right information, in response to reception of a user's request to access said logical volume.

8. The disk array system according to claim 7,
wherein said access is access for establishing definition of said logical volumes;
said access right information includes logical volume definition establishment authority information indicating whether it is permitted or prohibited to establish the definition of said logical volumes for said access; and
said access control means permits or prohibits establishment of the definition of said logical volumes, based on said logical volume definition establishment authority information.

9. The disk array system according to claim 8, comprising:
logical volume definition establishment implementation means for implementing said logical volume definition establishment according to a result of the determination made by said access control means on whether it is permitted or prohibited to establish the definition of said logical volumes.

10. The disk array system according to claim 7, wherein said access is access to data in said logical volumes; and
wherein said disk array system comprises path control means for permitting said access to meet said access request based on a result of the determination made by said access control means.

11. An access management method of managing an access from a user to a plurality of disk units, comprising the steps of:
determining whether said access is permitted or prohibited based on access right information defined for each user identifier with respect to each logical volume stored in each of said disk units, in response to a user's request to access said logical volumes; and
transmitting a result of the determination by the determining step to the user.

12. The access management method according to claim 11,
wherein said access is access for establishing definition of said logical volumes;
said access right information includes logical volume definition establishment authority information indicating whether it is permitted or prohibited to establish the definition of said logical volumes for said access; and
it is permitted or prohibited to establish the definition of said logical volumes, based on said logical volume definition establishment authority information.

13. The access management method according to claim 12,
wherein said establishment is implemented according to a result of the determination made on whether it is permitted or prohibited to establish the definition of said logical volumes.

14. An access management method of managing access to a plurality of disk units, comprising the steps of:
identifying information on a logical volume for which establishment of an access right is permitted with respect to a transmitted user identifier, based on said user identifier; and
establishing a user identifier for which an access right can be established with respect to said identified logical volume.
